(19) United States
(12) Patent Application Publication
(10) Pub. No.: US 2019/0287523 A1
(43) Pub. Date: Sep. 19, 2019

(54) FAR-FIELD VOICE CONTROL DEVICE AND FAR-FIELD VOICE CONTROL SYSTEM

(71) Applicant: Baidu Online Network Technology (Beijing) Co., Ltd., Beijing (CN)

(72) Inventors: Lifeng Zhao, Beijing (CN); Dengfeng Wu, Beijing (CN); Rentai Xing, Beijing (CN); Jie Chen, Beijing (CN)

(21) Appl. No.: 16/295,881

(22) Filed: Mar. 7, 2019

(30) Foreign Application Priority Data
Mar. 14, 2018 (CN) 201810208870.6

(51) Int. Cl. G10L 15/22; H04L 12/12; H04W 52/02; G10L 15/30; G10L 15/08; G06F 3/16

(52) U.S. Cl. CPC G10L 15/22; H04L 12/12; H04W 52/0235; G10L 2015/223; G10L 15/08; G06F 3/167; G10L 2015/088; G10L 15/30

(57) ABSTRACT

Embodiments of the present disclosure disclose a far-field voice control device and a far-field voice control system. According to an embodiment, the far-field voice control device includes: a far-field voice pickup device and a voice analysis device. The far-field voice pickup device receives a voice sent by a user, and sends the voice to the voice analysis device. The voice analysis device analyzes the voice to determine whether the voice includes a preset wake-up word, and sends the voice to a cloud server communicating with the far-field voice control device if the voice includes the preset wake-up word. That is, a remote user may interact with the far-field voice control system supporting the far-field voice pickup function through voice, thereby achieving the corresponding control function.

### CROSS-REFERENCE TO RELATED APPLICATIONS

This application claims priority to Chinese Patent Application No. 201810208870.6, filed on Mar. 14, 2018, titled “far-field voice control device and far-field voice control system,” which is hereby incorporated by reference in its entirety.

### TECHNICAL FIELD

Embodiments of the present disclosure relates to the field of computer technology, and specifically to a far-field voice control device and a far-field voice control system.

### BACKGROUND

With the popularity of the computer technology, life nowadays has gradually entered the age of smart technology. The smart technology begins to be applied not just in electronic products such as computers, cell phones, and virtual reality (VR) glasses, but in every aspect of the basic life necessaries, for example, smart television, smart navigation, and smart home. The smart technology provides convenient and efficient services in every aspect of the life. The smart voice interaction technology is a smart technology presently widely applied.

The smart voice interaction generally refers to the new generation of interactive mode based on a voice input. That is, a feedback result may be obtained by speaking. The interactive mode is the most natural and relaxed interactive mode for human, which can efficiently free hands and may reduce the operation difficulty to the greatest extent.

### SUMMARY

Embodiments of the present disclosure provides a far-field voice control device and far-field voice control system.

In a first aspect, the embodiments of the present disclosure provide a far-field voice control device. The far-field voice control device includes a far-field voice pickup device and a voice analysis device. The far-field voice pickup device receives a voice sent by a user, and sends the voice to the voice analysis device. The voice analysis device analyzes the voice to determine whether the voice includes a preset wake-up word, and sends the voice to a cloud server communicating with the far-field voice control device if the voice includes the preset wake-up word.

In some embodiments, the far-field voice control device further includes a far-field playback device. The far-field playback device plays voice playback information received from the cloud server.

In some embodiments, the far-field playback device includes a power amplifier for amplifying a power of the voice playback information.

In some embodiments, after receiving the voice sent by the user, the far-field voice pickup device further denoises on the voice.

In some embodiments, the far-field voice control device further includes at least one of following networking components: a wireless local area network networking component, a Bluetooth networking component, or an infrared networking component. The far-field voice control device communicates with the cloud server and at least one smart device via at least one of the networking components.

In some embodiments, the far-field voice control device is mounted in a junction box, a panel of the junction box is a touch panel, and the touch panel is provided with a touch button and/or an indicator light.

In a second aspect, the embodiments of the present disclosure provide a far-field voice control system. The far-field voice control system includes a cloud server and the far-field voice control device according to any embodiment in the first aspect. The cloud server communicates with the far-field voice control device.

In some embodiments, the cloud server receives voice sent from the far-field voice control device, analyzes the voice to determine control information corresponding to the voice, and sends a control command including the control information to the far-field voice control device.

In some embodiments, when the control information includes voice playback information, a far-field playback device of the far-field voice control device plays the voice playback information.

In some embodiments, the far-field voice control system further includes at least one smart device. When the control information includes non-voice playback information, the far-field voice control device determines, from the at least one smart device, a smart device performing an operation corresponding to the non-voice playback information as a target smart device, and sends the non-voice playback information to the target smart device, to cause the target smart device to perform the operation corresponding to the non-voice playback information.

In some embodiments, the far-field voice control device receives the voice sent by a user, analyzes the voice to determine whether the voice includes a preset wake-up word, and sends the voice to the cloud server if the voice includes the preset wake-up word. The cloud server analyzes the voice to determine the control information corresponding to the voice, and sends the control command including the control information to the far-field voice control device. The far-field playback device of the far-field voice control device plays the voice playback information when the control information includes the voice playback information. When the control information includes the non-voice playback information, the far-field voice control device determines, from the at least one smart device, the smart device performing the operation corresponding to the non-voice playback information as the target smart device, and sends the non-voice playback information to the target smart device, to cause the target smart device to perform the operation corresponding to the non-voice playback information.

According to the far-field voice control device and the far-field voice control system proposed by the embodiments of the present disclosure, the voice sent by the user is received through the far-field voice pickup device of the far-field voice control device, so as to send the voice to the voice analysis device of the far-field voice control device. Afterwards, the voice analysis device analyzes the voice to determine whether the voice includes the preset wake-up word, and sends the voice to the cloud server communicating with the far-field voice control device in the situation where the voice includes the preset wake-up word. That is, the remote user may interact with the far-field voice control device and the far-field voice control system which support the far-field interaction function through voice, thereby achieving the corresponding control function. This helps to improve the convenience of the control.

### BRIEF DESCRIPTION OF THE DRAWINGS

After reading detailed descriptions of non-limiting embodiments given with reference to the following accompanying drawings, other features, objectives, and advantages of the present disclosure will be more apparent:

FIG. 1 is a schematic structural diagram of an embodiment of a far-field voice control device provided by the present disclosure;

FIG. 2 is a schematic structural diagram of another embodiment of the far-field voice control device provided by the present disclosure;

FIG. 3 is a schematic structural diagram of an embodiment of a far-field voice control system provided by the present disclosure;

FIG. 4 is a schematic structural diagram of another embodiment of the far-field voice control system provided by the present disclosure;

FIG. 5 is an internal interaction flowchart of an application scenario of the far-field voice control system provided by the present disclosure; and

FIG. 6 is an internal interaction flowchart of another application scenario of the far-field voice control system provided by the present disclosure.

### DETAILED DESCRIPTION OF EMBODIMENTS

The present disclosure will be further described below in detail in combination with the accompanying drawings and the embodiments. It should be appreciated that the specific embodiments described herein are merely used for explaining the relevant disclosure, rather than limiting the disclosure. In addition, it should be noted that, for the ease of description, only the parts related to the relevant disclosure are shown in the accompanying drawings. It should also be noted that the embodiments in the present disclosure and the features in the embodiments may be combined with each other on a non-conflict basis. The present disclosure will be described below in detail with reference to the accompanying drawings and in combination with the embodiments.

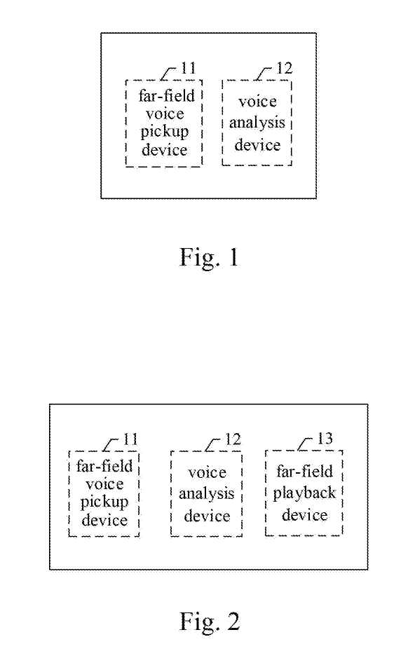

Referring to FIG. 1, which is a schematic structural diagram of an embodiment of a far-field voice control device provided by the present disclosure. The far-field voice control device in this embodiment may include a far-field voice pickup device 11 and a voice analysis device 12.

In this embodiment, the far-field voice pickup device 11 may first receive voice sent by a user, and then send the voice to the voice analysis device 12. The voice analysis device 12 may analyze the voice to determine whether the voice includes a preset wake-up word. In the situation where it is determined that the voice includes the preset wake-up word, the voice is sent to a cloud server communicating with the far-field voice control device.

In this embodiment, the far-field voice pickup device 11 may be various devices that can receive voice sent by a remote user, for example, a microphone array. The microphone array may be consisting of a certain number of acoustic sensors (generally microphones) having a certain spatial configuration, and used to perform sampling and processing on the spatial characteristics of the acoustic field. In practice, differences between the linear, circular, and spherical microphone arrays in principle are not much. The spatial ranges that may be recognized by the microphone arrays of different shapes are different only due to the different spatial configurations. For example, in sound source localization, the linear array only has one-dimensional information and only can recognize voice from 180 degrees. The circular array is a planar array that has two-dimensional information and can recognize voice from 360 degrees. The spherical array is a three-dimensional spatial array that has three-dimensional information and can recognize voice from 360-degree azimuth angle and a 180-degree pitch angle. Here, in order to facilitate the users at different positions performing the far-field voice control, the circular microphone array or the spherical microphone array is generally used as the far-field voice pickup device 11. Then, the larger the number of the microphones in the microphone array is, the finer the space that can be distinguished by a wave beam is, the higher the quality of the voice received in a noisy environment is. However, the larger the number of the microphones in the microphone array is, the higher the cost is. Therefore, the appropriate number of the microphones may be determined in combination with the distance of the far-field voice control.

In some alternative implementations of this embodiment, in order to improve the accuracy of the subsequent recognition of the voice, after receiving the voice sent by the user, the far-field voice pickup device 11 may also de-noise the voice using certain processing algorithms (e.g., a de-noising algorithm and an acoustic algorithm for eliminating an echo or removing a reverberation, etc.). For example, based on a beamforming based approach, the far-field voice pickup device 11 may form a pickup beam in a target direction and attenuate reflected sound from other directions at the same time by performing a weighted addition on the voice received by the plurality of microphones in the microphone array, thereby obtaining a clean voice.

In this embodiment, the voice analysis device 12 may analyze the voice received by the far-field voice pickup device 11 by using a common voice analysis method (e.g., a voice recognition method or a semantic understanding method). For example, the voice analysis device 12 may first perform voice recognition on the voice by using a voice recognition technology (automatic voice recognition, ASR), to convert the vocabulary content in the voice to the vocabulary content in a form of written language. Then, the vocabulary content in the form of written language is segmented into words using a word segmentation technique (e.g., an full segmentation method). Finally, it is determined that whether there is the preset wake-up word (e.g., “AA,” and “hello”) in the segmented words. In the situation where it is determined that the preset wake-up word is included in the voice, the voice is sent to the cloud server communicating with the far-field voice control device, so that the cloud server analyzes the voice and feeds back corresponding control information, to implement the far-field voice control on the far-field voice control device and/or a smart device communicating with the far-field voice control device. In the situation where it is determined that the preset wake-up word is not included in the voice, the flow is finished. That as, if the user wants to implement the far-field voice control on the far-field voice control device and/or the smart device communicating with the far-field voice control device, the user needs to simultaneously announce the preset wake-up word and the information for controlling the far-field voice control device and/or the smart device communicating with the far-field voice control device.

In this embodiment, the far-field voice control device may not only communicate with the cloud server, but also communicate with at least one smart device. Generally, the far-field voice control device may connect to a network by means of a wired connection or a wireless connection, to communicate with the cloud server. Similarly, when the at least one smart device is connected to the network, the far-field voice control device may also connect to the network by means of the wired connection or the wireless connection to communicate with the at least one smart device. In addition, when the at least one smart device is not connected to the network, a Bluetooth connection or an infrared connection may be established between the far-field voice control device and the at least one smart device. Therefore, the far-field voice control device may further include at least one of following networking components: a wireless local area network networking component, a Bluetooth networking component, or an infrared networking component. The far-field voice control device may communicate with the cloud server and the at least one smart device via at least one networking component.

As an example, the far-field voice control device may be provided with a wired port device. The wired port device may be connected to a network cable to implement the wired network connection. The wired port device may include a wired interface, for example, a socket in a RJ45 (Registered Jack 45, connector). In this way, when the connector of the network cable is inserted into the socket, the wired network connection may be realized. It may be understood that the wired connection may be plug and play without a trivial process of configuring the network. In such case, the network disconnection does not often occur, and thus the network runs stably.

As another example, the far-field voice control device may be configured with a wireless local area network networking component, for example, a Wi-Fi (Wireless Fidelity, wireless local area network) chip. The wireless local area network networking component may trigger the far-field voice control device to connect to a wireless local area network. In addition, the wireless local area network networking component may also be used as a Wi-Fi repeater. That is, when the far-field voice control device is connected to the wired network via the wired port device, the wireless local area network networking component may convert the wired network to a wireless network, for the at least one smart device to connect to and use. When the at least one smart device is connected to the wireless network, the far-field voice control device may communicate with the at least one smart device.

As still another example, the far-field voice control device may be configured with the Bluetooth networking component (e.g., a Bluetooth module). The Bluetooth networking component may trigger a short-range wireless communication established between the far-field voice control device and the at least one smart device. That the information may be transmitted between the far-field voice control device and the at least one smart device by using Bluetooth. In this way, in the situation where the at least one smart device is not connected to a network, the far-field voice control device can also interact with the at least one smart device.

As still another example, the far-field voice control device may be configured with the infrared networking component (e.g., an infrared module). The infrared networking component may have a built-in infrared transmitter and a built-in infrared receiver. The infrared transmitter may be used to transmit an infrared signal, and the infrared receiver may be used to receive the infrared signal. Generally, the at least one smart device may support infrared control. According to the control information fed back by the cloud server, the far-field voice control device may transmit a corresponding infrared signal to the corresponding smart device using the infrared transmitter, to control the corresponding smart device to perform a corresponding operation. For example, the switch of an air conditioner is controlled via the infrared signal, to adjust the operating parameters of the air conditioner such as the temperature, the wind speed, or the wind direction.

In some alternative implementations of this embodiment, the far-field voice control device may be mounted in a junction box, for example, in a switch or socket on a wall in a home, which may reduce the space occupied by the far-field voice control device, and is conductive to the aesthetic design of the room at the same time. In order to further expand the range of application of the far-field voice control device, the junction box herein may include various junction boxes of common specifications, for example, the 86-type junction box. Generally, the panel of the junction box may be a touch panel, and the touch panel may be provided with a touch button and/or an indicator light. In this way, by touching the touch button on the touch panel, the user may also adjust the control function of the far-field voice control device, for example, the on and off of the far-field voice control device. The indicator light may be used to indicate the status of the far-field voice control device such as on, off, or standby.

In the far-field voice control device provided by the embodiment of the present disclosure, the far-field voice pickup device of the far-field voice control device receives the voice sent by the user, so as to send the voice to the voice analysis device of the far-field voice control device. Afterwards, the voice analysis device analyzes the voice to determine whether the voice includes the preset wake-up word, and sends the voice to the cloud server communicating with the far-field voice control device when the voice includes the preset wake-up word. That is, the remote user may interact with a far-field voice control device or system supporting the far-field voice pickup function through voice, thereby achieving the corresponding control function. This helps to improve the convenience of the control.

Further referring to FIG. 2, which is a schematic structural diagram of another embodiment of a far-field voice control device provided by the present disclosure. The far-field voice control device in this embodiment may include a far-field voice pickup device 11, a voice analysis device 12, and a far-field playback device 13.

In this embodiment, the far-field voice pickup device 11 may first receive the voice sent by a user, and then send the voice to the voice analysis device 12. The voice analysis device 12 may analyze the voice to determine whether the voice includes a preset wake-up word, and send the voice to a cloud server communicating with the far-field voice control device in the situation where the voice includes the preset wake-up word. At the same time, the voice control device may further include the far-field playback device 13. The far-field playback device 13 may receive voice playback information from the cloud server, and play the voice playback information received from the cloud server.

In this embodiment, the far-field playback device 13 may be formed by combining a plurality of speakers in different orientations, so that users at different positions can receive the voice playback information. Generally, the far-field playback device 13 is provided with a power amplifier for amplifying the power of the voice playback information. In this way, the volume of the voice playback information played back by the far-field playback device 13 may be increased, so that a user who is far away from the far-field voice control device may also receive the voice playback information well.

It may be seen from FIG. 2, as compared with the embodiment corresponding to FIG. 1, in this embodiment a far-field playback device 13 is added to the far-field voice control device. Therefore, the far-field voice control device described in this embodiment not only supports the far-field voice pickup function, but also supports the far-field playback function, so that the far-field voice control device supports the far-field voice interaction function.

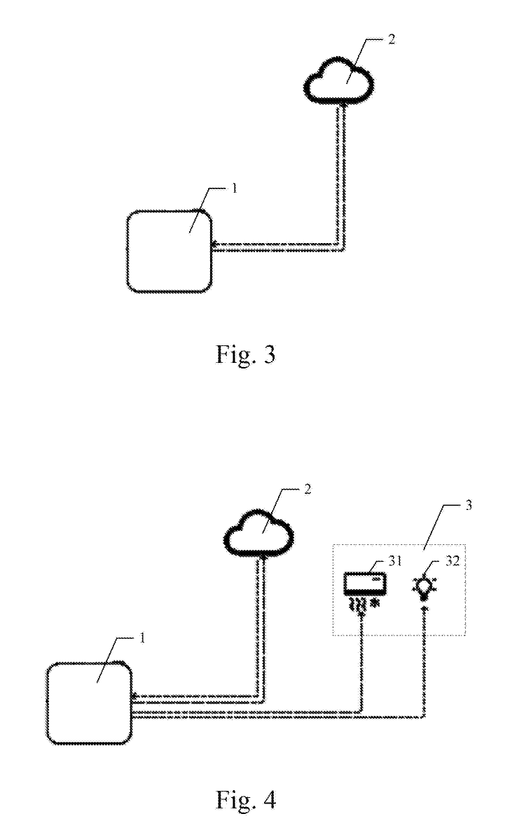

The embodiments of the present disclosure further provide a far-field voice control system. The far-field voice control system may include the cloud server and the far-field voice control device described in the foregoing embodiments. The cloud server may be in communication with the far-field voice control device. As an example, the far-field voice control system may be as shown in FIG. 3, which is a schematic structural diagram of an embodiment of the far-field voice control system provided by the present disclosure.

As shown in FIG. 3, the far-field voice control system may include the cloud server 2 and the far-field voice control device 1. The cloud server 2 is in communication with the far-field voice control device 1.

In this embodiment, the communication connection. between the cloud server 2 and the far-field voice control device 1 may be established through various approaches, including, but not limited to, a wired network connection or a wireless network connection.

In this embodiment, the cloud server 2 may receive the voice sent by the far-field voice control device 1, and analyze the voice to determine the control information corresponding to the voice. Then, the cloud server sends the control command containing the control information to the far-field voice control device 1, to make the far-field voice control device 1 perform the operation corresponding to the control information. Alternatively, the far-field voice control device 1 sends the control command including the control information to the corresponding smart device, to make the corresponding smart device perform the operation corresponding to the control information. For example, the cloud server 2 may pre-store a sample voice set and sample control information corresponding to each piece of sample voice. Specifically, the cloud server 2 may first acquire the voice from the far-field voice control device 1 communicating with the cloud server 2; and then match the voice with the each piece of sample voice in the sample voice set one by one. If there is a piece of sample voice in the sample voice set identical or similar to the voice, the piece of sample voice matches the voice. In such case, the cloud server 2 may find the sample control information corresponding to the piece of sample voice to be used as the control information corresponding to the voice, and feed back the control information to the far-field voice control device 1 to make the far-field voice control device 1 perform the operation corresponding to the control information. Alternatively, the far-field voice control device 1 sends the control command containing the control information to the corresponding smart device, to make the corresponding smart device perform the operation corresponding to the control information.

In some alternative implementations of this embodiment, when the control information includes the voice playback information, the far-field playback device of the far-field voice control device 1 plays the voice playback information. In this way, the voice playback information is played using the far-field playback device, so that the voice playback information may be well received by the remote user. For example, if the control information is the audio of the song XX, the far-field playback device of the far-field voice control device 1 may play the audio information of the song XX.

In some alternative implementations of this embodiment, the far-field voice control system may further include at least one smart device, and the far-field voice control device 1 may be communicating with the at least one smart device. Generally, when the at least one smart device is connected to the network, the far-field voice control device may also connect to the network by means of a wired connection or a wireless connection to communicate with the at least one smart device. In addition, when the at least one smart device is not connected to the network, a Bluetooth connection or an infrared connection may be established between the far-field voice control device and the at least one smart device. When the control information includes non-voice playback information, the far-field voice control device 1 may first determine, from the at least one smart device, a smart device that performs the operation corresponding to the non-voice playback information as a target smart device, and then send the non-voice playback information to the target smart device to make the target smart device perform the operation corresponding to the non-voice playback information. For example, if the control information is “turning on the air conditioner, “the far-field voice control device 1 determines the air conditioner from the at least one smart device, and sends the control command to the air conditioner to control the operation of the air conditioner.

The far-field voice control system proposed by the embodiments of the present disclosure receives the voice sent by the user through the far-field voice pickup device of the far-field voice control device, so as to send the voice to the voice analysis device of the far-field voice control device. Afterwards, the voice analysis device analyzes the voice to determine whether the voice includes the preset wake-up word, and sends the voice to the cloud server communicating with the far-field voice control device in the situation where the voice includes the preset wake-up word. That is, the remote user may interact with the far-field voice control system supporting the far-field voice pickup function through voice, thereby achieving the corresponding control function. It helps to improve the convenience of the control.

Further referring to FIG. 4, which is a schematic structural diagram of another embodiment of the far-field voice control system provided by the present disclosure. The far-field voice control system in this embodiment may include a far-field voice control device 1, a cloud server 2, and at least one smart device 3 (the light bulb 32 and the air conditioner 31 are shown in FIG. 4).

In this embodiment, the far-field voice control device 1 may first receive voice sent by a user, and then analyze the voice to determine whether the voice includes a preset wake-up word. If the voice includes the preset wake-up word, the voice is sent to the cloud server 2. The cloud server 2 may analyze the voice to determine the control information corresponding to the voice, and send the control command including the control information to the far-field voice control device 1. When the control information includes voice payback information, the far-field playback device of the far-field voice control device 1 plays the voice playback information. When the control information includes non-voice playback information, the far-field voice control device 1 determines, from the at least one smart device 3, a smart device (e.g., the air conditioner 32) that performs the operation corresponding to the non-voice playback information as a target smart device, and sends the non-voice playback information to the target smart device. The target smart device performs the operation corresponding to the non-voice playback information.

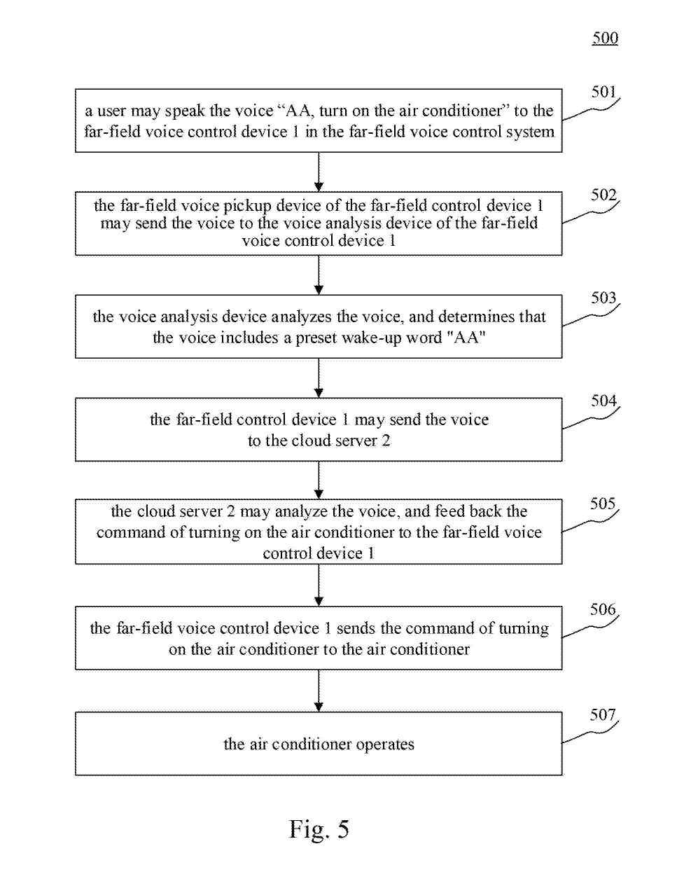

The embodiments of the present disclosure also provide an application scenario of the far-field voice control system. FIG. 5 illustrates an internal interaction flow 500 of an application scenario of the far-field voice control system provided by the present disclosure. First, as shown at 501, the user may speak the voice “AA, turn on the air conditioner” to the far-field voice control device 1 in the far-field voice control system. Then, as shown at 502, the far-field voice pickup device of the far-field control device 1 may send the voice to the voice analysis device of the far-field voice control device 1. Then, as shown at 503, the voice analysis device analyzes the voice, and determines that the voice includes the preset wake-up word “AA.” As shown at 504, the far-field control device 1 may send the voice to the cloud server 2. Then, as shown at 505, the cloud server 2 may analyze the voice, and feed back the command of turning on the air conditioner to the far-field voice control device 1. Next, as shown at 506, the far-field voice control device 1 sends the command of turning on the air conditioner to the air conditioner. Finally, as shown at 507, the air conditioner operates.

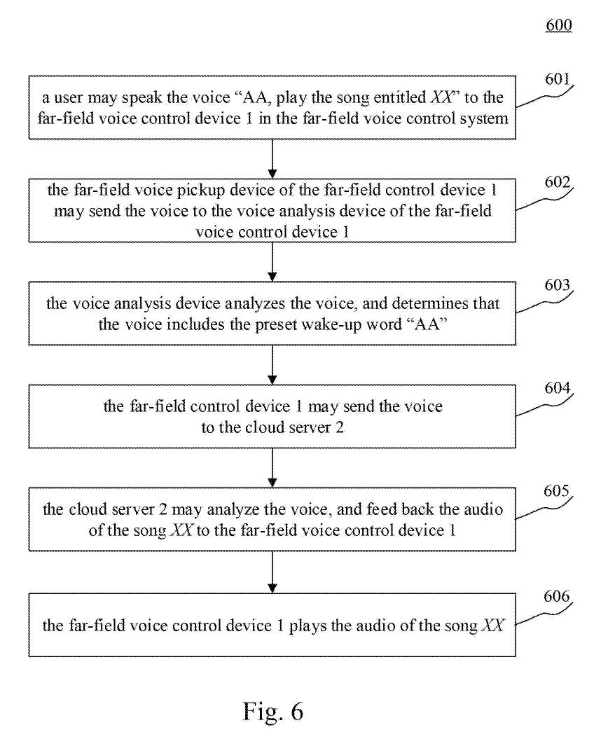

The embodiments of the present disclosure further provide another application scenario of the far-field voice control system. FIG. 6 illustrates an internal interaction flow 600 of another application scenario of the far-field voice control system provided by the present disclosure. First, as shown at 601, the user may speak the voice “AA, play the song entitled XX” to the far-field voice control device 1 in the far-field voice control system. Then, as shown at 602, the far-field voice pickup device of the far-field control device 1 may send the voice to the voice analysis device of the far-field voice control device 1. Then, as shown at 603, the voice analysis device analyzes the voice, and determines that the voice includes the preset wake-up word “AA.” Next, as shown at 604, the field control device 1 may send the voice to the cloud server 2. Afterwards, as shown at 605, the cloud server 2 may analyze the voice, and feed back the audio of the song XX to the far-field voice control device 1. Finally, as shown at 606, the far-field voice control device 1 plays the audio of the song XX.

The far-field voice control system proposed by the embodiments of the present disclosure receives the voice sent by the user through the far-field voice pickup device of the far-field voice control device, so as to send the voice to the voice analysis device of the far-field voice control device. Afterwards, the voice analysis device analyzes the voice to determine whether the voice includes the preset wake-up word, and sends the voice to the cloud server communicating with the far-field voice control device when the voice includes the preset wake-up word. The cloud server analyzes the voice to determine the control information corresponding to the voice, so as to control the corresponding device to perform the operation corresponding to control information. That is, the remote user may interact with the far-field voice control system supporting the far-field interaction function through voice, thereby achieving the corresponding control function. This helps to improve the convenience of the control.

The above description only provides an explanation of the preferred embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the disclosure. Technical schemes formed by the above-described features being interchanged with, but not limited to, technical features with similar functions disclosed in the present disclosure are examples.

What is claimed is:

1. A far-field voice control device, comprising a far-field voice pickup device and a voice analysis device,
the far-field voice pickup device picking up a voice sent by a user, and sending the voice to the voice analysis device, and
the voice analysis device analyzing the voice to determine whether the voice includes a preset wake-up word, and sending the voice to a cloud server communicating with the far-field voice control device when the voice includes the preset wake-up word.

2. The device according to claim 1, further comprising a far-field playback device, wherein the far-field playback device plays voice playback information received from the cloud server.

3. The device according to claim 2, wherein the far-field playback device includes a power amplifier for amplifying power of the voice playback information.

4. The device according to claim 1, wherein, after receiving the voice sent by the user, the far-field voice pickup device further denoises the voice.

5. The device according to claim 1, further comprising at least one of following networking components: a wireless local area network networking component, a Bluetooth networking component, or an infrared networking component, wherein the far-field voice control device communicates with the cloud server and at least one smart device via at least one of the networking components.

6. The device according to claim 1, wherein the far-field voice control device is mounted in a junction box, a panel of the junction box is a touch panel, and the touch panel is provided with a touch button and/or an indicator light.

7. A far-field voice control system, comprising a cloud server and a far-field voice control device, the cloud server communicating with the far-field voice control device.

8. The system according to claim 7, wherein the cloud server receives a voice sent from the far-field voice control device, analyzes the voice to determine control information corresponding to the voice, and sends a control command including the control information to the far-field voice control device.

9. The system according to claim 8, wherein, when the control information includes voice playback information, a far-field playback device of the far-field voice control device plays the voice playback information.

10. The system according to claim 8, further comprising at least one smart device, wherein, when the control information includes non-voice playback information, the far-field voice control device determines, from the at least one smart device, a smart device performing an operation corresponding to the non-voice playback information as a target smart device, and sends the non-voice playback information to the target smart device, to cause the target smart device to perform the operation corresponding to the non-voice playback information.

11. The system according to claim 10, wherein,
the far-field voice control device receives a voice sent by a user, analyzes the voice to determine the voice includes a preset wake-up word, and sends the voice to the cloud server if the voice includes the preset wake-up word;
the cloud server analyzes the voice to determine the control information corresponding to the voice, and sends the control command including the control information to the far-field voice control device;
when the control information includes the voice playback information, the far-field playback device of the far-field voice control device plays the voice playback information; and
when the control information includes the non-voice playback information, the far-field voice control device determines, from the at least one smart device, the smart device performing the operation corresponding to the non-voice playback information as the target smart device, and sends the non-voice playback information to the target smart device, to cause the target smart device to perform the operation corresponding to the non-voice playback information.

12. The system according to claim 7, wherein the far-field voice control device comprises a far-field voice pickup device and a voice analysis device,
the far field voice pickup device picking up a voice sent by a user, and sending the voice to the voice analysis device, and
the voice analysis device analyzing the voice to determine whether the voice includes a preset wake-up word, and sending the voice to a cloud server communicating with the far-field voice control device when the voice includes the preset wake-up word.

13. The system according to claim 12, wherein the far-field voice control device further comprises a far-field playback device, the far-field playback device includes a power amplifier for amplifying power of the voice playback information.

13. The system according to claim 12, wherein after receiving the voice sent by the user, the far-field voice pickup device further denoises the voice.

14. The system according to claim 12, wherein the far-field voice control device further comprises at least one of following networking components: a wireless local area network networking component, a Bluetooth networking component, or an infrared networking component, wherein the far-field voice control device communicates with the cloud server and at least one smart device via at least one of the networking components.

15. The system according to claim 12, wherein the far-field voice control device is mounted in a junction box, a panel of the junction box is a touch panel, and the touch panel is provided with a touch button and/or an indicator light.
